(19) United States
(12) Patent Application Publication
(10) Pub. No.: US 2026/0292877 A1
(43) Pub. Date: Sep. 24, 2026

(54) METHODS AND APPARATUSES FOR S-SSB TRANSMISSION IN UNLICENSED SPECTRA

(71) Applicant: LENOVO (BEIJING) LIMITED, Beijing (CN)

(72) Inventors: Xin Guo, Beijing (CN); Haipeng Lei, Beijing (CN); Zhennian Sun, Beijing (CN); Xiaodong Yu, Beijing (CN); Yu Zhang, Beijing (CN)

(21) Appl. No.: 18/996,251

(22) PCT Filed: Jul. 20, 2022
(86) PCT No.: PCT/CN2022/106903

§ 371 Date: Jan. 17, 2025

(51) Int. Cl. H04W 74/0816; H04L 27/26; H04W 74/08; H04W 92/18

(52) U.S. Cl. CPC H04W 74/0816; H04L 27/2605; H04W 74/0875; H04W 74/0891; H04W 92/18

(57) ABSTRACT

Embodiments of the present disclosure relate to methods and apparatuses for sidelink synchronization signal block (S-SSB) transmission in unlicensed spectra. According to an embodiment of the present disclosure, a user equipment (UE) can include: a processor configured to: obtain configuration information for S-SSB in an unlicensed spectrum based on configuration or pre-configuration, wherein the configuration information includes condition (s) for determining a channel access failure prior to a target S-SSB occasion based on a listen before talk (LBT) type 1 procedure; perform a first LBT type 1 procedure associated with a first S-SSB occasion to initiate a first S-SSB channel occupancy starting from the first S-SSB occasion; and perform at least one of the following operations in response to determining a channel access failure prior to the first S-SSB occasion based on the first LBT type 1 procedure and the configuration information: performing a second LBT type 1 procedure associated with a second S-SSB occasion next to the first S-SSB occasion to initiate a second S-SSB channel occupancy starting from the second S-SSB occasion; continuing to perform the first LBT type 1 procedure prior to the second S-SSB occasion to initiate a second S-SSB channel occupancy starting from the second S-SSB occasion; or performing a first LBT type 2 procedure; a transmitter coupled to the processor and configured to transmit an S-SSB on the first S-SSB occasion in response to a channel being available for access prior to the first S-SSB occasion based on the first LBT type 1 procedure; and a receiver coupled to the processor.

### TECHNICAL FIELD

Embodiments of the present application are related to wireless communication technology, and more particularly, related to methods and apparatuses for sidelink (SL) synchronization signal block (SSB) transmission in unlicensed spectra.

### BACKGROUND

A sidelink is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

Sidelink synchronization information is carried in an SL SSB (S-SSB). In an unlicensed spectrum, before an S-SSB transmission, a channel access procedure may be performed. Therefore, new designs for S-SSB transmission in unlicensed spectra are needed.

### SUMMARY OF THE APPLICATION

Embodiments of the present application at least provide a technical solution for S-SSB transmission in unlicensed spectra.

According to some embodiments of the present application, a UE may include: a processor configured to: obtain configuration information for S-SSB in an unlicensed spectrum based on configuration or pre-configuration, wherein the configuration information includes condition(s) for determining a channel access failure prior to a target S-SSB occasion based on a listen before talk (LBT) type 1 procedure; perform a first LBT type 1 procedure associated with a first S-SSB occasion to initiate a first S-SSB channel occupancy starting from the first S-SSB occasion; and perform at least one of the following operations in response to determining a channel access failure prior to the first S-SSB occasion based on the first LBT type 1 procedure and the configuration information: performing a second LBT type 1 procedure associated with a second S-SSB occasion next to the first S-SSB occasion to initiate a second S-SSB channel occupancy starting from the second S-SSB occasion; continuing to perform the first LBT type 1 procedure prior to the second S-SSB occasion to initiate a second S-SSB channel occupancy starting from the second S-SSB occasion; or performing a first LBT type 2 procedure; a transmitter coupled to the processor and configured to transmit an S-SSB on the first S-SSB occasion in response to the channel being available for access prior to the first S-SSB occasion based on the first LBT type 1 procedure; and a receiver coupled to the processor.

In some embodiments of the present application, the condition(s) for determining a channel access failure prior to a target S-SSB occasion based on an LBT type 1 procedure includes at least one of: a defer duration of the LBT type 1 procedure cannot finish prior to the target S-SSB occasion associated with the LBT type 1 procedure; or a random back-off procedure of the LBT type 1 procedure cannot finish prior to the target S-SSB occasion.

In some embodiments of the present application, the configuration information further comprises at least one of: a first mapping between channel access priority class (CAPC) value(s) and priority(ies) for synchronization reference; a second mapping between CAPC value(s) and channel occupancy time(s) (COT(s)); or a third mapping between length(s) of cyclic prefix extension (CPE) and priority(ies) for synchronization reference.

In some embodiments of the present application, a higher priority for synchronization reference is mapped to a smaller CAPC value; a COT with a shorter length is mapped to a smaller CAPC value; or a higher priority for synchronization reference is mapped to a longer CPE.

In some embodiments of the present application, the processor is configured to perform at least one of: determining a CAPC value based on a priority for synchronization reference of the UE and the first mapping or based on a COT of the first S-SSB channel occupancy and the second mapping; performing the first LBT type 1 procedure based on the CAPC value; or transmitting a CPE to occupy a channel until the beginning of the first S-SSB occasion in response to the channel being available for access prior to the first S-SSB occasion based on the first LBT type 1 procedure.

In some embodiments of the present application, the processor is further configured to perform a second LBT type 2 procedure associated with the second S-SSB occasion after the transmitter transmits the S-SSB on the first S-SSB occasion.

In some embodiments of the present application, the processor is configured to perform at least one of: determining a time interval between the first S-SSB occasion and the second S-SSB occasion and a sensing interval within the time interval, wherein a length of the sensing interval is based on at least one of: an LBT type of the second LBT type 2 procedure or a length of the time interval; performing the second LBT type 2 procedure associated with the second S-SSB occasion in the sensing interval; or transmitting a CPE to occupy a channel until the beginning of the second S-SSB occasion in response to the second LBT type 2 procedure being successful before the beginning of the second S-SSB occasion.

In some embodiments of the present application, the processor is configured to perform at least one of: determining a CAPC value based on a priority for synchronization reference of the UE and the first mapping; performing the second LBT type 1 procedure based on the CAPC value; or transmitting a CPE to occupy a channel until the beginning of the second S-SSB occasion in response to the channel being available for access prior to the second S-SSB occasion based on the second LBT type 1 procedure.

In some embodiments of the present application, the processor is configured to perform at least one of: determining a CAPC value based on a COT of the second channel occupancy and the second mapping; performing the second LBT type 1 procedure based on the CAPC value; or transmitting a CPE to occupy a channel until the beginning of the second S-SSB occasion in response to the channel being available for access prior to the second S-SSB occasion based on the second LBT type 1 procedure.

In some embodiments of the present application, the processor is further configured to transmit dummy data to occupy a channel until the beginning of the second S-SSB occasion after the channel is determined to be available for access at a time instant after the beginning of the first S-SSB occasion based on the first LBT type 1 procedure.

In some embodiments of the present application, the processor is further configured to: perform a third LBT type 1 procedure associated with the second S-SSB occasion based on a smallest CAPC value after the channel is determined to be available for access at a time instant after the beginning of the first S-SSB occasion based on the first LBT type 1 procedure.

In some embodiments of the present application, the first LBT type 2 procedure is performed within a time interval between the first S-SSB occasion and the second S-SSB occasion, and the processor is configured to perform at least one of: determining a length of a sensing interval within the time interval based on an LBT type of the first LBT type 2 procedure; performing the first LBT type 2 procedure within the sensing interval; or transmitting a CPE to occupy a channel until the beginning of the second S-SSB occasion in response to the channel being available for access based on the first LBT type 2 procedure.

In some embodiments of the present application, the first LBT type 2 procedure is performed prior to the first S-SSB occasion in response to determining a channel access failure prior to the first S-SSB occasion based on the first LBT type 1 procedure, and the processor is configured to perform at least one of: determining a length of a sensing interval within the time interval based on an LBT type of the first LBT type 2 procedure; performing the first LBT type 2 procedure within the sensing interval; or transmitting a CPE to occupy a channel until the beginning of the first S-SSB occasion in response to the channel being available for access based on the first LBT type 2 procedure.

In some embodiments of the present application, the receiver is configured to receive the configuration information via at least one of: a master information block (MIB) message, a system information block (SIB) message, a radio resource control (RRC) signaling, or a medium access control (MAC) control element (CE).

According to some other embodiments of the present application, a BS may include: a transmitter configured to: transmit configuration information for S-SSB in an unlicensed spectrum, wherein the configuration information includes at least one of the following: condition(s) for determining a channel access failure prior to a target S-SSB occasion based on an LBT type 1 procedure; a first mapping between CAPC value(s) and priority(ies) for synchronization reference; a second mapping between CAPC value(s) and COT(s); or a third mapping between length(s) of CPE and priority(ies) for synchronization reference; a processor coupled to the transmitter; and a receiver coupled to the processor.

In some embodiments of the present application, the condition(s) for determining a channel access failure prior to a target S-SSB occasion based on an LBT type 1 procedure includes at least one of: a defer duration of the LBT type 1 procedure cannot finish prior to the target S-SSB occasion associated with the LBT type 1 procedure; or a random back-off procedure of the LBT type 1 procedure cannot finish prior to the target S-SSB occasion.

In some embodiments of the present application, the configuration information is transmitted via at least one of: a MIB message, a SIB message, an RRC signaling, or a MAC CE.

According to some other embodiments of the present application, a method performed by a UE may include: obtaining configuration information for S-SSB in an unlicensed spectrum based on configuration or pre-configuration, wherein the configuration information includes condition(s) for determining a channel access failure prior to a target S-SSB occasion based on an LBT type 1 procedure; performing a first LBT type 1 procedure associated with a first S-SSB occasion to initiate a first S-SSB channel occupancy starting from the first S-SSB occasion; performing at least one of the following operations in response to determining a channel access failure prior to the first S-SSB occasion based on the first LBT type 1 procedure and the configuration information: performing a second LBT type 1 procedure associated with a second S-SSB occasion next to the first S-SSB occasion to initiate a second S-SSB channel occupancy starting from the second S-SSB occasion; continuing to perform the first LBT type 1 procedure prior to the second S-SSB occasion to initiate a second S-SSB channel occupancy starting from the second S-SSB occasion; or performing a first LBT type 2 procedure; and transmitting an S-SSB on the first S-SSB occasion in response to a channel being available for access prior to the first S-SSB occasion based on the first LBT type 1 procedure.

According to some other embodiments of the present application, a method performed by a BS may include: transmitting configuration information for S-SSB in an unlicensed spectrum, wherein the configuration information includes at least one of the following: condition(s) for determining a channel access failure prior to a target S-SSB occasion based on an LBT type 1 procedure; a first mapping between CAPC value(s) and priority(ies) for synchronization reference; a second mapping between CAPC value(s) and COT(s); or a third mapping between length(s) of CPE and priority(ies) for synchronization reference.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary S-SSB slot according to some embodiments of the present application;

FIG. 3 illustrates an exemplary distribution of S-SSB occasions according to some embodiments of the present application;

FIG. 4 illustrates an exemplary distribution of S-SSB occasions within one S-SSB period including a plurality of S-SSB windows according to some embodiments of the present application

FIG. 5 illustrates a flowchart of an exemplary procedure for performing COT-based S-SSB transmissions in an unlicensed spectrum according to some embodiments of the present application;

FIG. 6 illustrates an exemplary channel access procedure according to some embodiments of the present application;

FIG. 7 illustrates an exemplary channel access procedure according to some other embodiments of the present application;

FIG. 8 illustrates an exemplary channel access procedure according to some other embodiments of the present application;

FIG. 9 illustrates an exemplary channel access procedure according to some other embodiments of the present application;

FIG. 10 illustrates an exemplary channel access procedure according to some other embodiments of the present application;

FIG. 11 illustrates an exemplary channel access procedure according to some other embodiments of the present application;

FIG. 12 illustrates an exemplary channel access procedure according to some other embodiments of the present application;

FIG. 13 illustrates an exemplary channel access procedure according to some other embodiments of the present application; and

FIG. 14 illustrates a simplified block diagram of an exemplary apparatus for S-SSB transmission in an unlicensed spectrum according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

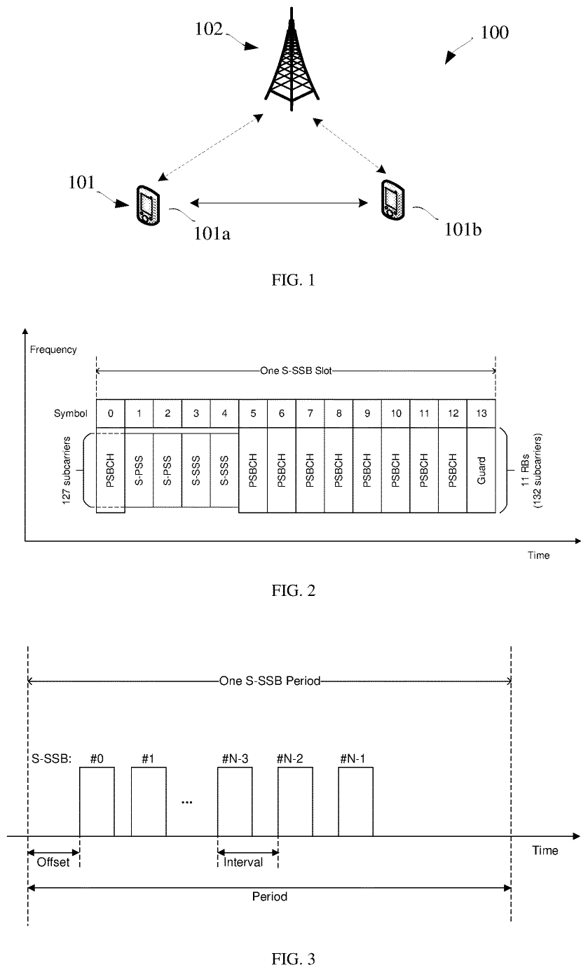

FIG. 1 illustrates an exemplary wireless communication system 100 in accordance with some embodiments of the present application.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present disclosure, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present disclosure, the UE(s) 101 may include wearable devices, such as smart watches, fitness bands, optical head-mounted displays, or the like.

According to some embodiments of the present disclosure, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present disclosure, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session.

Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

In some embodiments of the present disclosure, UE 101a may communicate with UE 101b over licensed spectrums, whereas in other embodiments, UE 101a may communicate with UE 101b over unlicensed spectrums.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present disclosure, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

In some embodiments of the present disclosure, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS(s) 102 may communicate using other communication protocols, such as the IEEE 802.11 family of wireless communication protocols. Further, in some embodiments of the present disclosure, BS(s) 102 may communicate over licensed spectrums, whereas in other embodiments, BS(s) 102 may communicate over unlicensed spectrums. The present disclosure is not intended to be limited to the implementation of any particular wireless communication system architecture or protocol. In yet some embodiments of the present disclosure, BS(s) 102 may communicate with UE(s) 101 using the 3GPP 5G protocols.

In NR, accommodating multiple uncoordinated UEs in an unlicensed spectrum requires channel access procedures defined for NR. Following a successful channel access procedure performed by a communicating node, the channel can be used by the communicating node during a period until the end of the period. Such a period may be referred to as a COT. During a COT, one or more transmissions may be exchanged between the communicating nodes, wherein a transmission may be a downlink transmission or an uplink transmission.

Dynamic channel access procedures are usually used by a BS or a UE to access a channel in an unlicensed spectrum. Dynamic channel access procedures may be based on LBT, where a transmitter listens to potential transmission activity on a channel prior to transmitting and applies a random back-off time in some cases. Two main types of dynamic channel access procedures may be defined in NR. One is Type-1 dynamic channel access procedure, which is also referred to as LBT type 1 or LBT cat4. The other is Type-2 dynamic channel access procedure, which is also referred to as LBT type 2.

Type-1 dynamic channel access procedure may be used to initiate data transmission at the beginning of a COT. The initiator for the Type-1 dynamic channel access procedure may be either a BS or a UE. The Type-1 dynamic channel access procedure may be summarized as follows.

First, the initiator listens and waits until a channel (e.g., a frequency channel) is available during at least one period referred to as a defer duration. The defer duration may consist of 16 μs and a number (e.g., “mₚ” in the following Table 1 or Table 2, which will be illustrated below) of 9 μs slots. As shown in Table 1 and Table 2, a value of “mₚ” depends on a value of CAPC (represented as “p”). Accordingly, the defer duration depends on the value of CAPC as shown in the following Table 1 or Table 2. A channel is declared to be available if the received energy during at least 4 μs of each 9 μs slot is below a threshold.

Once the channel has been declared available during the defer duration, the transmitter starts a random back-off procedure during which it will wait a random period of time.

The UE starts the random back-off procedure by initializing a back-off timer with a random number within a contention window (CW). The random number is drawn from a uniform distribution [0, CW] and represents that the channel must be available for a timer duration (e.g., defined by the random number multiplying 9 μs) before transmission can take place. The value of “CW” may be selected from “allowed CWₚ sizes” (the minimum value is represented as CW_{min,p} and the maximum value is represented as CW_{max,p}) in the following Table 1 or Table 2, which depends on a value of CAPC.

The back-off timer is decreased by one for each sensing slot duration (e.g., 9 μs) the channel is sensed to be idle; whenever the channel is sensed to be busy, the back-off timer is put on hold until the channel has been idle for a defer duration.

Once the back-off timer has expired (e.g., the back-off timer is decreased to be 0), the random back-off procedure is completed, and the transmitter has acquired the channel and can use it for transmission up to MCOT (e.g., T_{mcot,p} in the following Table 1 or T_{ulmcot,p} in the following Table 2, which depends on a value of CAPC).

The following Table 1 and Table 2 illustrate exemplary CAPC for DL and CAPC for UL, respectively, and corresponding values of mₚ, CW_{min,p}, CW_{max,p} T_{mcot,p}, T_{ulmcot,p} and allowed CWₚ sizes. Table 1 is the same as Table 4.1.1-1 in TS 37.213 and Table 2 is the same as Table 4.2.1-1 in TS 37.213. When a BS intends to initiate a channel occupancy for DL transmission, it may determine a CAPC value before performing a Type-1 channel access procedure, and then determine the corresponding values (e.g., mₚ, CW_{min,p}, CW_{max,p}, T_{mcot,p}, and allowed CWₚ sizes) used in the Type-1 channel access procedure according to Table 1. When a UE intends to initiate a channel occupancy for UL transmission, it may determine a CAPC value before performing a Type-1 channel access procedure, and then determine the corresponding values (e.g., mₚ, CW_{min,p}, CW_{max,p}, T_{ulmcot,p} and allowed CWₚ sizes) used in the Type-1 channel access procedure according to Table 2.

TABLE 1
Channel Access Priority Class for DL

| Channel | | | | | |
|---|---|---|---|---|---|
| Access | | | | | |
| Priority | | | | | |
| Class | | | | | |
| (p) | mₚ | CW_{min,p} | CW_{max,p} | T_{mcot,p} | allowed CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, |
| | | | | 10 ms | 255, 511, 1023} |

TABLE 2
Channel Access Priority Class for UL

| Channel | | | | | |
|---|---|---|---|---|---|
| Access | | | | | |
| Priority | | | | | |
| Class | | | | | |
| (p) | mₚ | CW_{min,p} | CW_{max,p} | T_{ulmcot,p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulmcot,p} = 10 ms if the higher layer parameter ‘absenceOfAnyOtherTechnology-r14’ indicates TRUE, otherwise, T_{ulmcot,p} = 6 ms.
NOTE 2:
When T_{ulmcot,p} = 6 ms it may be increased to 8 ms by inserting one or more gaps. The minimum duration of a gap shall be 100 μs. The maximum duration before including any such gap shall be 6 ms.

The size of the contention window may be adjusted based on hybrid automatic repeat request (HARQ) reports received from the transmitter during a reference interval, which covers the beginning of the COT. For each received HARQ report, the contention window is (approximately) doubled up to the limit CW_{max,p} if a negative HARQ report (e.g., non-acknowledgement (NACK)) is received. For a positive HARQ report (e.g., acknowledgement (ACK)), the contention window is reset to its minimum value, i.e., CW=CW_{min,p}.

Type-2 dynamic channel access procedure may be used for COT sharing and transmission of discovery bursts. Depending on a duration of a gap (also referred to as “COT sharing gap”) in the COT, Type-2 dynamic channel access procedure may be further divided into the following three procedures, wherein which procedure to be used may be determined depending on the duration of the gap between two transmission bursts.
Type 2A dynamic channel access procedure (also referred to as LBT cat2 or LBT type 2A): which is used when the gap is 25 μs or more for transmission of the discovery bursts.
Type 2B dynamic channel access procedure (also referred to as LBT type 2B): which is used when the gap is 16 μs.
Type 2C dynamic channel access procedure (also referred to as LBT type 2C): which is used when the gap is 16 μs or less after the preceding transmission burst.

For Type 2C dynamic channel access procedure, no idle sensing is required between the transmission bursts. In such scenario, the duration of a transmission burst is limited to at most 584 μs. Such a short transmission burst may carry small amount of user data, uplink control information (UCI) such as HARQ status reports and channel state information (CSI) reports.

Type 2A dynamic channel access procedure and Type 2B dynamic channel access procedure may be similar to Type-1 dynamic channel access procedure but without the random back-off. That is, in Type 2A dynamic channel access procedure and Type 2B dynamic channel access procedure, if a channel is detected to be idle in the gap, it is declared to be available; if it is detected to be busy, the COT sharing has failed and the transmission cannot occur using COT sharing in this COT. If the COT sharing gap is 16 μs, Type 2B dynamic channel access procedure may be used and the channel must be detected to be idle in the 16 μs gap prior to the next transmission burst. If the COT sharing gap is 25 μs or longer, Type 2A dynamic channel access procedure may be used and the channel must be detected to be idle during at least 25 μs immediately preceding the next transmission burst.

The above embodiments provide several dynamic channel access procedures in an unlicensed spectrum for NR. These dynamic channel access procedures may also apply for sidelink transmissions in an unlicensed spectrum.

Sidelink synchronization information is carried in an S-SSB that consists of physical sidelink broadcast channel (PSBCH), sidelink primary synchronization signal (S-PSS) and sidelink secondary synchronization signal (S-SSS). FIG. 2 illustrates an exemplary S-SSB slot according to some embodiments of the present disclosure. In the embodiments of FIG. 2, a normal cyclic prefix (CP) is used.

Referring to FIG. 2, an S-SSB occupies one slot in the time domain and occupies 11 resource blocks (RBs) in the frequency domain. Each RB spans 12 subcarriers, thus the S-SSB bandwidth is 132 (11×12) subcarriers. In the example of FIG. 2, the S-SSB slot may include 14 OFDM symbols in total, e.g., symbol #0 to symbol #13. The S-PSS is transmitted repeatedly on the second and third symbols in the S-SSB slot, e.g., symbol #1 and symbol #2. The S-SSS is transmitted repeatedly on the fourth and fifth symbols in the S-SSB slot, e.g., symbol #3 and symbol #4. The S-PSS and the S-SSS occupy 127 μsubcarriers in the frequency domain, which are from the third subcarrier relative to the start of the S-SSB bandwidth up to the 129th subcarrier.

The S-PSS and the S-SSS are jointly referred to as the sidelink synchronization signal (SLSS). The SLSS is used for time and frequency synchronization. By detecting the SLSS sent by a synchronization reference UE (also referred to as a SyncRef UE), a UE is able to synchronize to the SyncRef UE and estimate the beginning of the frame and carrier frequency offsets.

The S-PSS may be generated from the maximum length sequences (m-sequences) that use the same design (i.e., generator polynomials, initial values and cyclic shifts, etc.) which is used for generating the m-sequences in the primary synchronization signal (PSS) in the 3GPP documents. In NR Uu, there are three candidate sequences for PSS. However, only two candidate sequences are used for S-PSS.

The S-SSS may be generated from the Gold sequences that use the same design (i.e., generator polynomials, initial values and cyclic shifts, etc.) which is utilized for generating the Gold sequences for the secondary synchronization signal (SSS) in the 3GPP documents. This results in 336 candidate sequences for S-SSS like for the SSS in NR Uu.

For the transmission of SLSS within an S-SSB, a SyncRef UE may select an S-PSS and an S-SSS out of the candidate sequences based on an SLSS identifier (ID).

The SLSS ID represents an identifier of the SyncRef UE and conveys a priority of the SyncRef UE as in LTE V2X. Each SLSS ID corresponds to a unique combination of an S-PSS and an S-SSS out of the 2 S-PSS candidate sequences and the 336 S-SSS candidate sequences.

The main purpose of the PSBCH is to provide system-wide information and synchronization information that is required by a UE for establishing a sidelink connection. In the example of FIG. 2, the PSBCH is transmitted on the first symbol (e.g., symbol #0) and the eight symbols (e.g., symbol #5 to symbol #12) after the S-SSS in the S-SSB slot. In the case that an extended CP is used, the PSBCH is transmitted on the first symbol and the six symbols after the S-SSS in the S-SSB slot. The PSBCH occupies 132 μsubcarriers in the frequency domain. The PSBCH in the first symbol of the S-SSB slot is used for automatic gain control (AGC). The last symbol, e.g., symbol #13, in the S-SSB slot is used as a guard symbol.

A UE may be configured with a configuration for an S-SSB period including one or more S-SSB occasions.

FIG. 3 illustrates an exemplary distribution of S-SSB occasions according to some embodiments of the present disclosure.

As shown in FIG. 3, within one S-SSB period, N S-SSB occasions are included, which are S-SSB #0, S-SSB #1, . . . , S-SSB #N−3, S-SSB #N−2, and S-SSB #N−1, respectively. A length of the S-SSB period is marked as “Period.” There is an offset from the starting slot of the S-SSB period to the first S-SSB occasion within the S-SSB period, e.g., S-SSB #0, which is marked as “Offset” in FIG. 3. There is an interval between two adjacent S-SSB occasions (e.g., between starting slots of the two adjacent S-SSB occasions). For example, as shown in FIG. 3, the interval between S-SSB #N−3 and S-SSB #N−2 is marked as “Interval.” Accordingly, the configuration for one S-SSB period may include at least one of the parameter “Period,” the parameter “Offset,” or the parameter “Interval.” A UE may select one or more SSB occasions for transmitting SSB(s) based on the configuration.

The S-SSB period may include 16 frames, e.g., 160 ms, as specified in NR V2X. Possible numbers of S-SSB occasions within one S-SSB period are shown in the following Table 3:

TABLE 3
Number of S-SSB occasions within an S-SSB Period (160 ms)

| Frequency | Subcarrier spacing | Number of S-SSB |
|---|---|---|
| range | (SCS) | occasions per period |
| FR1 | 15 kHz | 1 |
| | 30 kHz | 1, 2 |
| | 60 kHz | 1, 2, 4 |
| FR2 | 60 kHz | 1, 2, 4, 8, 16, 32 |
| | 120 kHz | 1, 2, 4, 8, 16, 32, 64 |

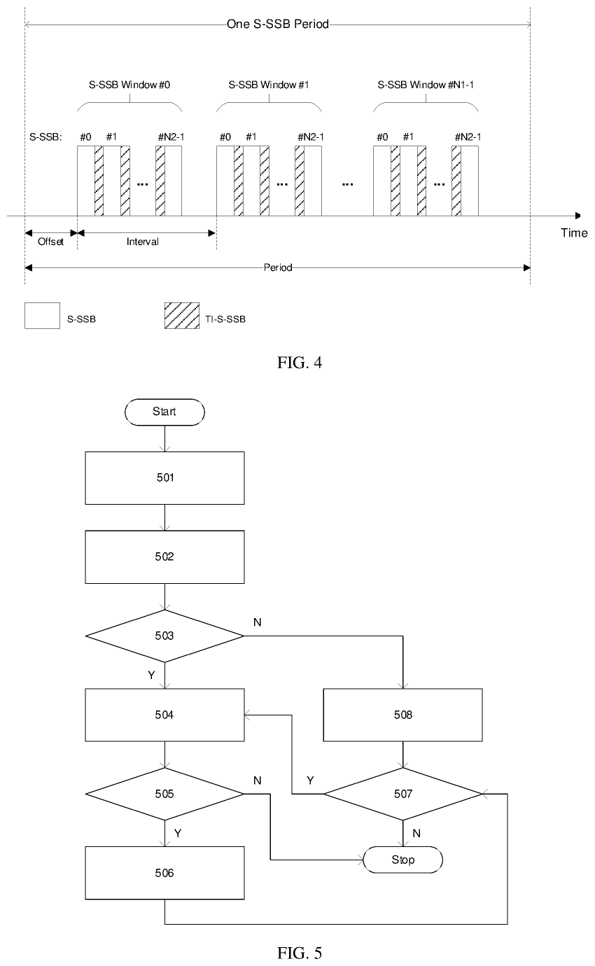

FIG. 4 illustrates an exemplary distribution of S-SSB occasions within one S-SSB period including a plurality of S-SSB windows according to some embodiments of the present application.

Referring to FIG. 4, in the S-SSB period, N1 S-SSB windows are included, which are S-SSB window #0, S-SSB window #1, . . . , S-SSB window #N1−1, respectively. In each S-SSB window, N2 S-SSB occasions are included, which are S-SSB occasion #0, S-SSB occasion #1, . . . , S-SSB occasion #N2−1, respectively. In each S-SSB window, a time interval (e.g., denoted by TI-S-SSB) locates between two adjacent S-SSB occasions. The length of the S-SSB period is marked as “Period.” The time duration from the starting slot of the S-SSB period to the starting slot of the S-SSB window #0 is marked as “Offset.” The interval between two adjacent S-SSB windows (e.g., from the starting slot of the S-SSB window #0 to the starting slot of the S-SSB window #1) is marked as “Interval.”

The structure of S-SSB slot in FIG. 2 and distribution of occasions for S-SSB in FIGS. 3 and 4 are only for illustrative purpose. It is contemplated that along with developments of network architectures and new service scenarios, the S-SSB may have other structures (for example, the S-SSB may include 4 OFDM symbols in the time domain) and the distribution of occasions for S-SSB within one S-SSB period or within one window may change, which should not affect the principle of the present application.

For an S-SSB transmission in an unlicensed spectrum, in the time domain, one important requirement is that a UE needs to perform a channel access procedure (e.g., an LBT procedure) before the S-SSB transmission.

Compared to the licensed spectrum, more S-SSB occasions may be needed for the unlicensed spectrum for the following two reasons. One is to achieve desirable channel access opportunities for the UE. The other is for S-SSB to be used in new scenarios, such as supporting latency-critical traffics, supporting beam-based transmission, and so on.

In addition, if accessing each S-SSB occasion needs an independent LBT procedure with a long time, the energy consumption will be scaled largely with the number of S-SSB transmissions.

Given the above, the COT-based S-SSB transmissions in unlicensed spectrum are needed for sidelink. To guarantee a desired channel access opportunity, the UE's behaviour for performing the COT-based S-SSB transmissions needs to be specified. For example, the UE's behaviour includes but is not limited to the operations performed by the UE when a channel access procedure for initiating the COT-based S-SSB transmissions is determined to be failed and the operations performed by the UE when a channel access procedure for initiating the COT-based S-SSB transmissions is successful.

Embodiments of the present application provide improved solutions for S-SSB transmission in an unlicensed spectrum, which propose configurations, signalings, and procedures for performing COT-based S-SSB transmissions in unlicensed band. More details will be described in the following text in combination with the appended drawings.

According to some embodiments of the present application, a UE may obtain configuration information for S-SSB in an unlicensed spectrum based on configuration or pre-configuration. The configuration information may be used by the UE to perform COT-based S-SSB transmissions.

In some embodiments of the present application, the UE may obtain the configuration information based on configuration. Specifically, obtaining the configuration information based on configuration (i.e., the configuration information is configured to the UE) may refer to that: the configuration information is transmitted by a BS (e.g., BS 102 as shown in FIG. 1) to the UE via at least one of: a SIB message, a MIB message, an RRC signaling, or a MAC CE, or downlink control information (DCI), such that the UE may receive the configuration information from the BS. In an embodiment of the present application, obtaining the configuration information based on configuration may apply to the scenario where the UE is in coverage of a network.

In some other embodiments of the present application, the UE may obtain the configuration information based on pre-configuration. Specifically, obtaining the configuration information based on pre-configuration (i.e., the configuration information is pre-configured to the UE) may refer to that: the configuration information may be hard-wired into the UE or stored on a subscriber identity module (SIM) or universal subscriber identity module (USIM) card for the UE, such that the UE may obtain the configuration information within the UE. In an embodiment of the present application, obtaining the configuration information based on pre-configuration may apply to the scenario where the UE is out of coverage of the network.

The configuration information for S-SSB in an unlicensed spectrum may include at least one of:
condition(s) for determining a channel access failure prior to a target S-SSB occasion (“prior to a target S-SSB occasion” may refer to “no later than the beginning of the target S-SSB occasion”) based on an LBT type 1 procedure;
a first mapping between CAPC value(s) and priority(ies) for synchronization reference;
a second mapping between CAPC value(s) and COT(s); or
a third mapping between length(s) of CPE (e.g., denoted by T_{CPE}) and priority(ies) for synchronization reference.

In some embodiments of the present application, the condition(s) for determining a channel access failure prior to a target S-SSB occasion based on an LBT type 1 procedure may include at least one of:
condition 1: a defer duration of the LBT type 1 procedure cannot finish prior to the target S-SSB occasion associated with the LBT type 1 procedure; or
condition 2: a random back-off procedure of the LBT type 1 procedure cannot finish prior to the target S-SSB occasion.

Such condition(s) may enable a UE to determine a channel access failure in advance, e.g., before the beginning (also referred to as starting boundary) of the target S-SSB occasion.

For example, when a UE intends to initiate an S-SSB channel occupancy (e.g., having a COT) starting from the target S-SSB occasion, the UE may perform an LBT type 1 procedure before the target S-SSB occasion. Without using the aforementioned condition(s), the UE may determine a channel access failure associated with the S-SSB channel occupancy starting from the target S-SSB occasion only when it determines that the channel is still unavailable for access at the beginning of the target S-SSB occasion based on the LBT type 1 procedure. That is, the UE cannot determine the channel access failure until the beginning of the target S-SSB occasion.

In contrast, by using the condition 1 or condition 2, the UE may determine the channel access failure before the beginning of the target S-SSB occasion. For example, at a time instant t1 for initiating the LBT type 1 procedure, the UE may determine a defer duration (denoted by T_{d}) of the LBT type 1 procedure (e.g., based on a CAPC value) and the time offset (calculated by a function of ΔT(*)) from the time instant t1 to the beginning of the target S-SSB occasion (denoted by t2), i.e., ΔT(t1, t2)=t2−t1. If ΔT(t1, t2) is less than T_{d}, i.e., ΔT(t1,t2)<T_{d}, which means that the defer duration of the LBT type 1 procedure cannot finish prior to the target S-SSB occasion, the condition 1 is met and thus the UE may determine the channel access failure at the time instant t1. A time instant may also be referred to as a time point.

In another example, at a time instant t3 in the random back-off procedure of the LBT type 1 procedure, the UE may determine the minimum time (denoted by Tₘᵢₙ) needed for finishing the remaining random back-off procedure and a time offset from the time instant t3 to the beginning of the target S-SSB occasion (i.e., t2), i.e., ΔT(t3, t2)=t2−t3. If ΔT(t3, t2) is less than Tₘᵢₙ, which means that the random back-off procedure of the LBT type 1 procedure cannot finish prior to the target S-SSB occasion, the condition 2 is met and thus the UE may determine the channel access failure at the time instant t3. For example, Tₘᵢₙ can be determined as follows: given that at t3 the counter for back-off is denoted by N and a sensing slot duration (e.g., 9 μs) is denoted by Tₛₗ, Tₘᵢₙ can be calculated by Tₘᵢₙ=N*Tₛₗ.

There are four basic synchronization references from which a UE may derive its own synchronization, i.e., global navigation satellite system (GNSS), its serving BS (e.g., eNB or gNB), another UE transmitting SLSS (e.g., which is referred to as a SyncRef UE), or its own internal clock. In general, GNSS or BS is regarded as the highest-quality sources. SyncRef UEs are distinguished between those which are directly synchronized to GNSS or BS, those which are 1 further step away from GNSS or BS, and those which are ≥2 further steps away from GNSS or BS. As a last resort, a UE unable to find any other synchronization reference will use its own internal clock to transmit SLSS. The preference order for synchronization references is as follows, with details specified in TS 36.331, wherein “Level 1” through “Level 5” are priorities for synchronization references from the highest to the lowest.
Level 1: the synchronization reference is either GNSS or BS, according to configuration or pre-configuration.
Level 2: the synchronization reference is a SyncRef UE directly synchronized to a Level 1 source.
Level 3: the synchronization reference is a SyncRef UE synchronized to a Level 2 source, i.e., indirectly synchronized to a Level 1 source.
Level 4: the synchronization reference is any other SyncRef UE.
Level 5: UE's internal clock.

In some embodiments of the present application, one principle of mapping between CAPC values and priorities for synchronization reference is providing an earlier channel access opportunity for a synchronization reference with a higher priority. In order to achieve the above principle, the first mapping between CAPC value(s) and priority(ies) for synchronization reference may map a higher priority for synchronization reference to a smaller CAPC value. Based on Table 1 or Table 2 above, a smaller CAPC value may correspond to a shorter sensing interval (the sensing interval may include the defer duration and the random back-off procedure) for an LBT type 1 procedure, thereby providing an earlier channel access opportunity.

The following Table 4 μshows an exemplary mapping between CAPC values (e.g., p) and priorities for synchronization reference

TABLE 4

| | Priority for |
|---|---|
| CAPC | synchronization |
| (p) | reference |
| 1 | Level 1 |
| 2 | Level 2 |
| 2 | Level 3 |
| 3 | Level 4 |
| 4 | Level 5 |

For example, in the case that the priority for synchronization reference is level 2, the corresponding CAPC value is 2 according to Table 4. Based on the CAPC value, the UE may determine a length of the sensing interval for an LBT type 1 procedure based on Table 1 or Table 2 above.

In some embodiments of the present application, one principle of mapping between CAPC values and COTs is providing an earlier channel access opportunity for a COT with a shorter length, e.g., a smaller number of S-SSBs (or S-SSB occasions) in the COT. In order to achieve the above principle, the second mapping between CAPC value(s) and COT(s) may map a COT with a shorter length (e.g., a COT with a smaller number of S-SSBs) to a smaller CAPC value. Based on Table 1 or Table 2 above, a smaller CAPC value may correspond to a shorter sensing interval for an LBT type 1 procedure, thereby providing an earlier channel access opportunity.

The following Table 5 μshows an exemplary mapping between CAPC values (e.g., p) and COTs for S-SSB, which is defined as the number of S-SSBs (i.e., j) within a COT.

TABLE 5

| CAPC | |
|---|---|
| (p) | COT for S-SSB (j) |
| 1 | j = [1 . . . floor(N_{S-SSB}^{MCOT}/4)] |
| 2 | j = (floor(N_{S-SSB}^{MCOT}/4) . . . 2* floor(N_{S-SSB}^{MCOT}/4)] |
| 3 | j = (2*floor(N_{S-SSB}^{MCOT}/4) . . . 3* floor(N_{S-SSB}^{MCOT}/4)] |
| 4 | j = (3*floor(N_{S-SSB}^{MCOT}/4) . . . N_{S-SSB}^{MCOT}] |

Referring to Table 5, j is the number of S-SSBs (or S-SSB occasions) in the COT and N_{S-SSB}^{MCOT} is the number of S-SSBs (or S-SSB occasions) included in the MCOT. For example, assuming that there are 8 S-SSBs in the MCOT and a COT has 3 S-SSBs, which is within a value range in the second row (e.g., j=(2 . . . 4] or j∈{3,4}) of Table 5, then the corresponding CAPC value is p=2. Based on the CAPC value, the UE may determine a length of the sensing interval for an LBT type 1 procedure based on Table 1 or Table 2 above.

In some embodiments of the present application, CPE may be transmitted to occupy a channel until the beginning of a target S-SSB when the channel is determined to be available based on an LBT procedure before the beginning of the target S-SSB, and one principle of mapping between lengths of CPE and priorities for synchronization reference is providing an earlier channel access opportunity for a synchronization reference with a higher priority. In order to achieve the above principle, the third mapping between length(s) of CPE and priority(ies) for synchronization reference may map a higher priority for synchronization reference to a longer CPE.

In some embodiments of the present application, the length of CPE may be determined by the following equation (1):

$${T}_{CPE} = {N}_{UT} * {T}_{UT} \qquad ( 1 )$$

In equation (1), T_{UT} is a unit of time configured or pre-configured to the UE, for example, T_{UT}=9 μs. N_{UT} is the number of units of time. In such embodiments, the third mapping may be a mapping between number(s) of units of time for calculating a length of CPE and priority(ies) for synchronization reference. In an embodiment, a higher priority for synchronization reference is mapped to the number of units of time associated with a longer CPE, thereby realizing the principle that the higher the priority for synchronization reference, the longer the T_{CPE}.

The following Table 6 μshows an exemplary mapping between CPE (represented by the number of units of time (e.g., N_{UT})) and priorities for synchronization reference.

TABLE 6

| | Priority for |
|---|---|
| CPE | synchronization |
| (N_{UT}) | reference |
| 4 | Level 1 |
| 3 | Level 2 |
| 2 | Level 3 |
| 1 | Level 4 |
| 0 | Level 5 |

For example, in the case that the priority for the synchronization reference is level 2, the number of units of time “N_{UT}” is 3 according to Table 6. Based on equation (1), the UE may determine that T_{CPE}=27 μs.

Based on the obtained configuration information, the UE may perform COT-based S-SSB transmissions in an unlicensed spectrum.

FIG. 5 illustrates a flowchart of an exemplary procedure for performing COT-based S-SSB transmissions in an unlicensed spectrum according to some embodiments of the present application. The procedure in FIG. 5 may at least include the following steps.

At the beginning of the procedure, a UE may intend to initiate a first S-SSB channel occupancy starting from an S-SSB occasion (e.g., S-SSB occasion #m) or an SSB (e.g., S-SSB #m). The first S-SSB channel occupancy may have a first COT, which starts from S-SSB occasion #m or S-SSB #m.

In some embodiments of the present application, the first COT may be defined as N_{S-SSB}^{COT} (S-SSB #m), which represents the number of S-SSBs intended to be transmitted by the UE within the first COT starting from S-SSB #m. The parameter N_{S-SSB}^{COT} (S-SSB #m) may be determined by the UE's intention and constrained by distribution of S-SSB occasions in time and N_{S-SSB}^{MCOT}, e.g., N_{S-SSB}^{COT} (S-SSB #m)≤N_{S-SSB}^{MCOT}, wherein N_{S-SSB}^{MCOT} represents the maximized number of S-SSBs that could be transmitted within a COT.

In step 501, the UE may initiate a COT counter (e.g., denoted by N_{C}) with an initial value being N_{S-SSB}^{COT} (S-SSB #m) (i.e., N_{C}=N_{S-SSB}^{COT} (S-SSB #m)). The UE may also set a COT flag (e.g., denoted by F_{C}) to be TRUE (i.e., F_{C}=TRUE). Then, the UE goes to step 502.

In step 502, the UE may perform a procedure I (e.g., a first LBT type 1 procedure) associated with (e.g., towards) S-SSB occasion #m to initiate the first S-SSB channel occupancy starting from S-SSB occasion #m. The specific operation for procedure I will be described in detail below. Then, the UE goes to step 503.

In step 503, the UE may determine whether or not the channel is available for access prior to S-SSB occasion #m based on procedure I. In response to the channel being available for access (i.e., “Y” branch of step 503), the UE goes to step 504. Else, in response to the channel access being failed (i.e., “N” branch of step 503), e.g., according to condition 1 or condition 2, the UE goes to step 508.

In step 504, the UE may transmit an S-SSB on the first available S-SSB occasion based on the corresponding channel access procedure. In addition, in step 504, the UE may also decrement N_{C} by one, i.e., set N_{C}=N_{C}−1. Then, the UE goes to step 505.

In step 505, the UE may determine whether or not the current value of N_{C} is greater than 0. In the case that the current value of N_{C} is greater than 0 (i.e., “Y” branch of step 505), which means that there is at least one S-SSB to be transmitted, the UE goes to step 506. Else, in the case that the current value of N_{C} is no greater than 0 (i.e., “N” branch of step 505), which means that all the intended S-SSBs have been transmitted, the UE stops the procedure.

In step 506, the UE may perform a procedure II (e.g., an LBT type 2 procedure) associated with (e.g., towards) a next S-SSB occasion within the first COT after the UE transmits an S-SSB on a previous S-SSB occasion. For example, the UE may perform an LBT type 2 procedure associated with S-SSB occasion #m+1 after transmitting the S-SSB on S-SSB occasion #m. The specific operations for procedure II will be described in detail below. Then, the UE goes to step 507.

In step 507, the UE may determine whether or not the channel is available for access. In response to the channel being available for access (i.e., “Y” branch of step 507), the UE goes to step 504. Else, in response to the channel access being failed (i.e., “N” branch of step 507), the UE stops the procedure.

In step 508, the UE may perform a procedure III (e.g., an LBT type 1 procedure or an LBT type 2 procedure) associated with S-SSB occasion #m or an S-SSB occasion (e.g., S-SSB occasion #m+1) next to S-SSB occasion #m. The specific operation for procedure III will be described in detail below. In procedure III, if an LBT type 2 procedure is performed, the UE may set N_{C}=1. Then, the UE goes to step 507.

### Procedure I

According to some embodiments of the present disclosure, in procedure I, the UE may perform a first LBT type 1 procedure associated with S-SSB occasion #m to initiate the first S-SSB channel occupancy starting from S-SSB occasion #m.

Procedure I may include at least one of the following steps.

Step 1-1: the UE may determine a CAPC value. In some embodiments of the present application, the UE may determine a CAPC value based on a priority for synchronization reference of the UE and the first mapping as described above. For example, based on Table 4 and the priority for synchronization reference of the UE, the UE may determine a corresponding CAPC value.

Alternatively, the UE may determine a CAPC value based on the first COT (e.g., N_{S-SSB}^{COT} (S-SSB #m)) of the first S-SSB channel occupancy and the second mapping as described above. For example, based on Table 5 and N_{S-SSB}^{COT} (S-SSB #m), the UE may determine a corresponding CAPC value.

Step 1-2: the UE may perform the first LBT type 1 procedure based on a CAPC value (e.g., the CAPC value determined in step 1-1). For example, based on the CAPC value, the UE may determine the parameters (e.g., “mₚ” for determining the length of the defer duration, “allowed CWp size” for determining the back-off counter, etc.) needed by the first LBT type 1 procedure based on Table 1 or Table 2.

Step 1-3: in response to a channel being available for access prior to S-SSB occasion #m based on the first LBT type 1 procedure (e.g., the first LBT type 1 procedure is successful before the beginning of S-SSB occasion #m), the UE may transmit a CPE to occupy the channel until the beginning of S-SSB occasion #m.

In some embodiments of the present application, the UE may determine a length of CPE based on the priority for synchronization reference of the UE and the third mapping as described above. The length of CPE (e.g., T_{CPE}) may indicate that the LBT procedure can start at a first time point prior to a second time point with an offset (e.g., T_{CPE}) relative to the beginning (i.e., starting boundary) of S-SSB occasion #m.

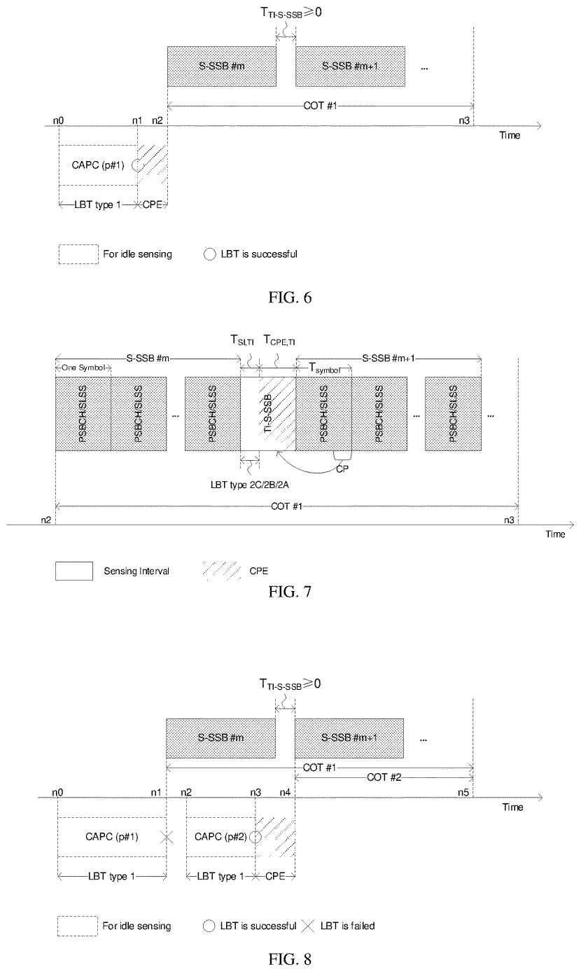

FIG. 6 illustrates an exemplary channel access procedure (e.g., procedure I) according to some embodiments of the present application.

As shown in FIG. 6, a UE may intend to initiate a first S-SSB channel occupancy starting from S-SSB occasion #m. The first S-SSB channel occupancy may have a first COT (e.g., denoted by COT #1) from a time point n2 to a time point n3, wherein n2 is the beginning (also referred to as starting boundary) of S-SSB occasion #m. The first COT may include N_{S-SSB}^{COT} (S-SSB #m) S-SSB occasions (or S-SSBs). A length of the time interval between two adjacent S-SSB occasions within the first COT may be denoted by T_{TI-S-SSB}, wherein T_{TI-S-SSB}≥0. For simplicity, FIG. 6 only illustrates two S-SSB occasions (e.g., S-SSB occasion #m and S-SSB occasion #m+1) as an example. For simplicity, S-SSB occasion #m and S-SSB occasion #m+1 are represented as S-SSB #m and S-SSB #m+1 in FIG. 6.

The UE may determine a CAPC value (e.g., denoted by p #1) based on the methods as described above. Then, before S-SSB occasion #m, the UE may perform a first LBT type 1 procedure associated with S-SSB occasion #m to initiate the first S-SSB channel occupancy based on the CAPC value. The starting point of the first LBT type 1 procedure may be at time point n0.

In response to the channel being available for access (e.g., the first LBT type 1 procedure is successful) at a time point n1 (wherein n1<n2) based on the first LBT type 1 procedure, the UE may transmit a CPE to occupy a channel until the beginning (e.g., n2) of S-SSB occasion #m as shown in FIG. 6.

Otherwise, in response to determining a channel access failure prior to S-SSB occasion #m (e.g., no later than the beginning of S-SSB occasion #m) based on the first LBT type 1 procedure (e.g., by using condition 1 or condition 2), the UE may perform procedure III, as illustrated in FIG. 5.

### Procedure II

According to some embodiments of the present disclosure, procedure II includes a channel access procedure to be performed by a UE when the UE intends to transmit an S-SSB within a COT, expect for the first S-SSB in the COT. Once the first S-SSB transmission in the COT is successful, the UE may perform procedure II for channel access for remaining S-SSB(s) until the end of the COT.

In procedure II, the UE may perform an LBT type 2 procedure, which may be one of LBT type 2C, LBT type 2B and LBT type 2A. In some embodiments, the LBT type (e.g., LBT type 2A, 2B, or 2C) of the LBT type 2 procedure may be indicated by the configuration information configured or pre-configured to the UE.

FIG. 7 illustrates an exemplary channel access procedure (e.g., procedure II) according to some embodiments of the present application.

In the example of FIG. 7, a first S-SSB channel occupancy starting from S-SSB occasion #m with a first COT (e.g., denoted by COT #1 from n2 to n3, as illustrated in FIG. 6) is initiated (e.g., by a successful procedure I) and an S-SSB is successfully transmitted on S-SSB occasion #m. Then, before transmitting an S-SSB on S-SSB occasion #m+1, the UE performs a channel access procedure, which may include at least one of the following steps.

Step 2-1: the UE may determine a time interval between S-SSB occasion #m and S-SSB occasion #m+1 and a sensing interval for an LBT type 2 procedure within the time interval.

A length of the time interval (e.g., denoted by T_{TI-S-SSB}) may be configured or pre-configured to the UE.

A length of the sensing interval (e.g., denoted by T_{SI,TI}) may be determined based on at least one of: an LBT type of the LBT type 2 procedure or a length of the time interval.

For example, the length of the sensing interval may be 0≤T_{SI,TI}≤16 μs when the LBT type is LBT type 2C or may be 0 when T_{TI-S-SSB}=0, or may be T_{SI,TI}=16 μs when the LBT type is LBT type 2B, or may be T_{SI,TI}≥25 μs when the LBT type is LBT type 2A.

Step 2-2: the UE may perform the LBT type 2 procedure associated with S-SSB occasion #m+1 in the sensing interval. For example, the UE may perform idle sensing within the sensing interval in response to the LBT type being LBT type 2B or LBT type 2A or no LBT in response to the LBT type being LBT type 2C or T_{TI-S-SSB}=0.

Step 2-3: the UE may transmit a CPE to occupy a channel until the beginning of S-SSB occasion #m+1 in response to the LBT type 2 procedure being successful before the beginning of S-SSB occasion #m+1. For example, the length of the CPE (e.g., T_{CPE,TI}) may be equal to T_{TI-SSB}−T_{SI,TI}.

Although FIG. 7 takes S-SSB occasion #m+1 as an example, the procedure in FIG. 7 may apply for any S-SSB occasion within the first COT except for the first S-SSB occasion (e.g., S-SSB occasion #m in FIG. 7).

### Procedure III

According to some embodiments of the present disclosure, procedure III includes a channel access procedure to be performed by a UE after determining a channel access failure prior to a first S-SSB occasion (e.g., S-SSB occasion #m) based on a first LBT type 1 procedure (e.g., by using condition 1 or condition 2).

Procedure III may include at least one of the following methods:
1) Method 1: performing a second LBT type 1 procedure associated with a second S-SSB occasion (e.g., S-SSB occasion #m+1) next to the first S-SSB occasion to initiate a second S-SSB channel occupancy starting from the second S-SSB occasion;
2) Method 2: continuing to perform the first LBT type 1 procedure prior to the second S-SSB occasion to initiate a second S-SSB channel occupancy starting from the second S-SSB occasion; or
3) Method 3: performing an LBT type 2 procedure.

In the case of Method 1 and Method 2, the UE intends to perform a COT-based S-SSB transmission starting from the second S-SSB occasion. In the case of Method 3, the UE intends to switch a COT-based S-SSB transmission (which is intendedly to be initiated by the first LBT type 1 procedure) to a single S-SSB transmission. That is the reason why the UE may set N_{C}=1 if an LBT type 2 procedure is performed in procedure III, as stated above with respect to step 508.

Two alternatives of Method 1, referred to as alternative 1 and alternative 2, are described below.

### Alternative 1

In alternative 1, the UE may perform at least one of the following steps:

Step 3-1-1-1: the UE may determine a CAPC value based on a priority for synchronization reference of the UE and the first mapping as described above.

Step 3-1-1-2: the UE may perform the second LBT type 1 procedure associated with the second S-SSB occasion (e.g., S-SSB occasion #m+1) based on a CAPC value (e.g., the CAPC value determined in step 3-1-1-1).

Step 3-1-1-3: the UE may transmit a CPE to occupy a channel until the beginning of the second S-SSB occasion (e.g., S-SSB occasion #m+1) in response to the channel being available for access prior to the second S-SSB occasion based on the second LBT type 1 procedure.

FIG. 8 illustrates an exemplary channel access procedure (e.g., alternative 1) according to some embodiments of the present application.

As shown in FIG. 8, a UE may perform a first LBT type 1 procedure (e.g., starting from a time point n0) associated with S-SSB occasion #m to initiate a first S-SSB channel occupancy starting from S-SSB occasion #m.

The first S-SSB channel occupancy may have a first COT (e.g., denoted by COT #1) from a time point n1 to a time point n5, wherein n1 is the beginning (also referred to starting boundary) of S-SSB occasion #m. The first COT may include N_{S-SSB}^{COT} (S-SSB #m) S-SSB occasions. A length of the time interval between two adjacent S-SSB occasions within the first COT may be denoted by T_{TI-S-SSB}, wherein T_{TI-S-SSB}≥0. For simplicity, FIG. 8 only illustrates two S-SSB occasions (e.g., S-SSB occasion #m and S-SSB occasion #m+1) as an example. For simplicity, S-SSB occasion #m and S-SSB occasion #m+1 are represented as S-SSB #m and S-SSB #m+1 in FIG. 8.

The first LBT type 1 procedure may be performed based on a CAPC value (e.g., denoted by p #1). In the example of FIG. 8, the UE may determine p #1 based on the priority for synchronization reference of the UE and the first mapping as described above.

In FIG. 8, a cross representing “LBT is failed” is marked at n1 for simplicity. However, the UE may determine a channel access failure prior to S-SSB occasion #m (i.e., no later than n1) based on the first LBT type 1 procedure. In some embodiments of the present application, the UE may determine a channel access failure prior to S-SSB occasion #m based on the condition(s) (e.g., condition 1 or condition 2) as described above.

In response to determining the channel access failure prior to S-SSB occasion #m, the UE may perform a second LBT type 1 procedure (e.g., starting from a time point n2) associated with S-SSB occasion #m+1 to initiate a second S-SSB channel occupancy starting from occasion #m+1. The second S-SSB channel occupancy may have a second COT (e.g., denoted by COT #2) starting from S-SSB occasion #m+1. The second COT may include N_{S-SSB}^{COT} (S-SSB #m+1) S-SSB occasions. In the example of FIG. 8, COT #1 and COT #2 have the same end time point (e.g., n5). In such case, COT #2 (from n4 to n5) is shorter than COT #1 (from n1 to n5). It is contemplated that, in some other embodiments, COT #1 and COT #2 may have different end time points, and COT #2 is not necessarily shorter than COT #1.

The second LBT type 1 procedure may be performed based on another CAPC value (e.g., denoted by p #2). The UE may determine p #2 based on the priority for synchronization reference of the UE and the first mapping as described above. Accordingly, p #2 may have the same value as p #1.

In response to a channel being available for access prior to S-SSB occasion #m+1 based on the second LBT type 1 procedure, e.g., the channel is determined to be available for access at a time point (e.g., n3) before the beginning (e.g., n4) of S-SSB occasion #m+1, the UE may transmit a CPE to occupy the channel until the beginning of S-SSB occasion #m+1.

### Alternative 2

In alternative 2, the UE may perform at least one of the following steps:

Step 3-1-2-1: the UE may determine a CAPC value based on a COT of the second channel occupancy and the second mapping as described above.

Step 3-1-2-2: the UE may perform the second LBT type 1 procedure based on a CAPC value (e.g., the CAPC value determined in step 3-1-2-1).

Step 3-1-2-3: the UE may transmit a CPE to occupy a channel until the beginning of the second S-SSB occasion (e.g., S-SSB occasion #m+1) in response to the channel being available for access prior to the second S-SSB occasion based on the second LBT type 1 procedure.

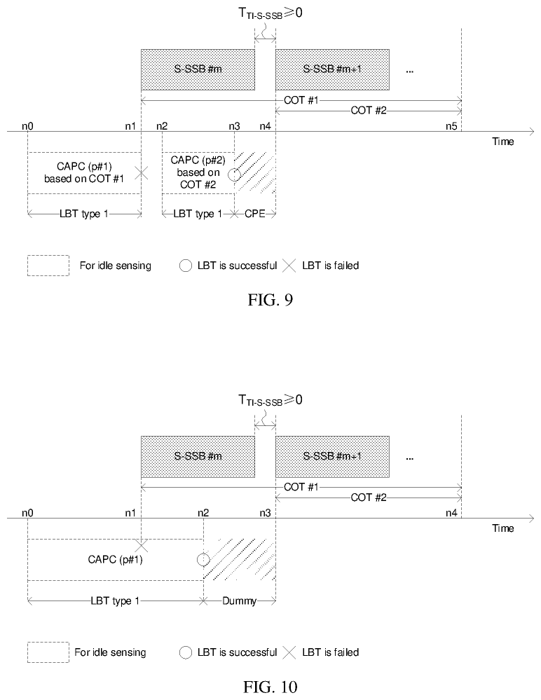

FIG. 9 illustrates an exemplary channel access procedure (e.g., alternative 2) according to some embodiments of the present application.

The parameters and operations of the UE illustrated in FIG. 9 may be similar to those illustrated in FIG. 8. The differences between the channel access procedure in FIG. 9 and that in FIG. 8 lie in that: in FIG. 9, CAPC value p #1 associated with the first LBT type 1 procedure is determined based on the first COT (e.g., N_{S-SSB}^{COT} (S-SSB #m)) of the first channel occupancy, and CAPC value p #2 associated with the second LBT type 1 procedure is determined based on the second COT (e.g., N_{S-SSB}^{COT} (S-SSB #m+1)) of the second channel occupancy.

In the example of FIG. 9, the first COT (e.g., denoted by COT #1) and the second COT (e.g., denoted by COT #2) have the same end time point (e.g., n5). In such case, the second COT (from n4 to n5) is shorter than the first COT (from n1 to n5). Based on the principle that a COT with a shorter length is mapped to a smaller CAPC value as described above, CAPC value p #2 may be smaller than CAPC value p #1. Accordingly, compared to alternative 1 illustrated in FIG. 8, the successful probability of channel access in alternative 2 illustrated in FIG. 9 may increase because the smaller CAPC value p #2 may correspond to a shorter sensing interval, thereby providing an earlier channel access opportunity. It is contemplated that, in some other embodiments, the first COT and the second COT may have different end time points, and the second COT is not necessarily shorter than the first COT.

Two alternatives of Method 2, referred to as alternative 3 and alternative 4, are described below.

### Alternative 3

In alternative 3, the UE may continue to perform the first LBT type 1 procedure prior to the second S-SSB occasion (e.g., S-SSB occasion #m+1) to initiate a second S-SSB channel occupancy starting from the second S-SSB occasion. The UE may occupy a channel (e.g., by transmitting dummy data or CPE) until the beginning of the second S-SSB occasion after the channel is determined to be available for access at a time instant after the beginning of the first S-SSB occasion based on the first LBT type 1 procedure.

FIG. 10 illustrates an exemplary channel access procedure (e.g., alternative 3) according to some embodiments of the present application.

As shown in FIG. 10, a UE may perform a first LBT type 1 procedure (e.g., starting from a time point n0) associated with S-SSB occasion #m to initiate a first S-SSB channel occupancy starting from S-SSB occasion #m.

The first S-SSB channel occupancy may have a first COT (e.g., denoted by COT #1) from a time point n1 to a time point n4, wherein n1 is the beginning (also referred to starting boundary) of S-SSB occasion #m. The first COT may include N_{S-SSB}^{COT} (S-SSB #m) S-SSB occasions. A length of the time interval between two adjacent S-SSB occasions within the first COT may be denoted by T_{TI-S-SSB}, wherein T_{TI-S-SSB}≥0. For simplicity, FIG. 10 only illustrates two S-SSB occasions, e.g., S-SSB occasion #m and S-SSB occasion #m+1, as an example. For simplicity, S-SSB occasion #m and S-SSB occasion #m+1 are represented as S-SSB #m and S-SSB #m+1 in FIG. 10.

The first LBT type 1 procedure may be performed based on a CAPC value (e.g., denoted by p #1), wherein p #1 may be determined based on the priority for synchronization reference of the UE and the first mapping as described above or based on the first COT (e.g., N_{S-SSB}^{COT} (S-SSB #m)) of the first channel occupancy and the second mapping as described above.

In FIG. 10, a cross representing “LBT is failed” is marked at n1 for simplicity. However, the UE may determine a channel access failure prior to S-SSB occasion #m (i.e., no later than n1) based on the first LBT type 1 procedure. In some embodiments of the present application, the UE may determine a channel access failure prior to S-SSB occasion #m based on the condition(s) (e.g., condition 1 or condition 2) as described above.

In response to determining the channel access failure prior to S-SSB occasion #m, the UE may continue to perform the first LBT type 1 procedure prior to S-SSB occasion #m+1 to initiate a second S-SSB channel occupancy starting from S-SSB occasion #m+1. The second S-SSB channel occupancy may have a second COT (e.g., denoted by COT #2) starting from S-SSB occasion #m+1. The second COT may include N_{S-SSB}^{COT} (S-SSB #m+1) S-SSB occasions. In the example of FIG. 10, COT #1 and COT #2 have the same end time point (e.g., n4). In such case, COT #2 (from n3 to n4) is shorter than COT #1 (from n1 to n4). It is contemplated that, in some other embodiments, COT #1 and COT #2 may have different end time points, and COT #2 is not necessarily shorter than COT #1.

In the case that the channel is determined to be available for access at a time instant (e.g., n2) after the beginning of the S-SSB occasion #m and before the beginning (e.g., n3) of S-SSB occasion #m+1 (i.e., n1<n2<n3), the UE may transmit dummy data to occupy the channel until the beginning of S-SSB occasion #m+1.

### Alternative 4

In alternative 4, the UE may continue to perform the first LBT type 1 procedure prior to the second S-SSB occasion (e.g., S-SSB occasion #m+1) to initiate a second S-SSB channel occupancy starting from the second S-SSB occasion. The UE may perform a third LBT type 1 procedure associated with the second S-SSB occasion (e.g., S-SSB occasion #m+1) based on a smallest CAPC value after the channel is determined to be available for access at a time instant after the beginning of the first S-SSB occasion based on the first LBT type 1 procedure.

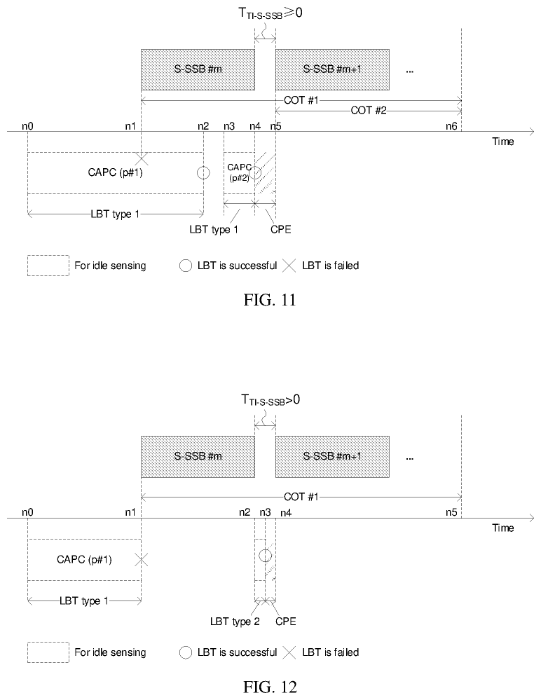

FIG. 11 illustrates an exemplary channel access procedure (e.g., alternative 4) according to some embodiments of the present application.

As shown in FIG. 11, the UE may perform a first LBT type 1 procedure (e.g., starting from a time point n0) associated with S-SSB occasion #m to initiate a first S-SSB channel occupancy starting from S-SSB occasion #m.

The first S-SSB channel occupancy may have a first COT (e.g., denoted by COT #1) from a time point n1 to a time point n6, wherein n1 is the beginning (also referred to starting boundary) of S-SSB occasion #m. The first COT may include N_{S-SSB}^{COT} (S-SSB #m) S-SSB occasions. A length of the time interval between two adjacent S-SSB occasions within the first COT may be denoted by T_{TI-S-SSB}, wherein T_{TI-S-SSB}≥0. For simplicity, FIG. 11 only illustrates two S-SSB occasions, e.g., S-SSB occasion #m and S-SSB occasion #m+1, as an example. For simplicity, S-SSB occasion #m and S-SSB occasion #m+1 are represented as S-SSB #m and S-SSB #m+1 in FIG. 11.

Before a time point n2 in FIG. 11, the UE may perform the same operations as those described with respect to FIG. 10. For example, in response to determining the channel access failure prior to S-SSB occasion #m, the UE may continue to perform the first LBT type 1 procedure prior to S-SSB occasion #m+1 to initiate a second S-SSB channel occupancy starting from S-SSB occasion #m+1. The second S-SSB channel occupancy may have a second COT (e.g., denoted by COT #2) starting from S-SSB occasion #m+1. The second COT may include N_{S-SSB}^{COT} (S-SSB #m+1) S-SSB occasions. In the example of FIG. 11, COT #1 and COT #2 have the same end time point (e.g., n6). In such case, COT #2 (from n5 to n6) is shorter than COT #1 (from n1 to n6). It is contemplated that, in some other embodiments, COT #1 and COT #2 may have different end time points, and COT #2 is not necessarily shorter than COT #1.

The difference is that: in FIG. 11, after the channel is determined to be available for access at n2, the UE may perform a third LBT type 1 procedure associated with S-SSB occasion #m+1 based on a smallest CAPC value (e.g., denoted by p #2) among the CAPC values configured or pre-configured to the UE.

The third LBT type 1 procedure may start at a time instant (e.g., n3) before S-SSB occasion #m+1.

In the case that the channel is determined to be available for access at a time instant (e.g., n4) before the beginning (e.g., n5) of S-SSB occasion #m+1, the UE may transmit a CPE to occupy the channel until the beginning of S-SSB occasion #m+1.

Compared to alternative 4, the successful probability of channel access in alternative 3 may be higher because alternative 3 provides an earlier channel access opportunity by occupying the channel with dummy data. However, the earlier channel access opportunity for alternative 3 is achieved at the cost of lower spectrum efficiency.

Two alternatives of Method 3, referred to as alternative 5 and alternative 6, are described below.

### Alternative 5

In alternative 5, in response to determining a channel access failure prior to the first S-SSB occasion (e.g., S-SSB occasion #m) based on the first LBT type 1 procedure, the UE may perform an LBT type 2 procedure associated with the second S-SSB occasion (e.g., S-SSB occasion #m+1). That is, the LBT type 2 procedure may be performed within a time interval between the first S-SSB occasion and the second S-SSB occasion. In alternative 5, the LBT type 2 procedure may be one of LBT type 2B and LBT type 2A. In some embodiments, the LBT type (e.g., LBT type 2A or 2B) of the LBT type 2 procedure may be indicated by the configuration information configured or pre-configured to the UE.

FIG. 12 illustrates an exemplary channel access procedure (e.g., alternative 5) according to some embodiments of the present application.

As shown in FIG. 12, a UE may perform a first LBT type 1 procedure (e.g., starting from a time point n0) associated with S-SSB occasion #m to initiate a first S-SSB channel occupancy starting from S-SSB occasion #m.

The first S-SSB channel occupancy illustrated in FIG. 12 may be the same as the first S-SSB channel occupancy illustrated in FIG. 8. In addition, the operations for determining a channel access failure prior to S-SSB occasion #m based on the first LBT type 1 procedure performed by the UE in the example of FIG. 12 may be same as those described with respect to FIG. 8.

The difference is that: in FIG. 12, in response to determining a channel access failure prior to S-SSB occasion #m based on the first LBT type 1 procedure, the UE performs an LBT type 2 procedure associated with S-SSB #m+1 within a time interval (greater than zero) between S-SSB occasion #m and S-SSB occasion #m+1. The specific operations may include at least one of the following steps.

Step 3-3-1-1: the UE may determine a length of a sensing interval within the time interval based on an LBT type of the first LBT type 2 procedure.

Step 3-3-1-2: the UE may perform the LBT type 2 procedure within the sensing interval.

In some cases, the UE may determine a length of CPE based on a priority for synchronization reference of the UE and the third mapping as described above. For example, a higher priority for synchronization reference may be mapped to a longer CPE. In some embodiments of the present application, the length of a CPE may be determined by T_{CPE}=N_{UT}*T_{UT}. In such embodiments, T_{UT} is a unit of time configured or pre-configured for the UE, and N_{UT} is the number of units of time determined based on a priority for synchronization reference of the UE and the third mapping as described above. In such cases, the earliest starting point of the LBT type 2 procedure is T_{SI}+T_{CPE} relative to the beginning (e.g., n4) of S-SSB occasion #m+1, wherein T_{SI} is the length of the sensing interval and T_{CPE} is the length of CPE. In the example of FIG. 12, the starting point of the LBT type 2 procedure is n2.

Step 3-3-1-3: in the case that a channel is determined to be available for access based on the first LBT type 2 procedure at time point n3, the UE may transmit a CPE to occupy the channel until the beginning (e.g., time point n4) of S-SSB occasion #m+1.

In addition, according to some embodiments of the present application, the method of alternative 5 may be triggered in response to the remaining duration of the first COT (e.g., the number of remaining S-SSB occasions in the first COT) is below a threshold configured or pre-configured for the UE.

### Alternative 6

In alternative 6, in response to determining a channel access failure prior to the first S-SSB occasion (e.g., S-SSB occasion #m) based on the first LBT type 1 procedure, the UE may perform an LBT type 2 procedure associated with the first S-SSB. That is, the LBT type 2 procedure may be performed prior to the first S-SSB occasion. In alternative 6, the LBT type 2 procedure may be one of LBT type 2B and LBT type 2A. In some embodiments, the LBT type (e.g., LBT type 2A or 2B) of the LBT type 2 procedure may be indicated by the configuration information configured or pre-configured to the UE.

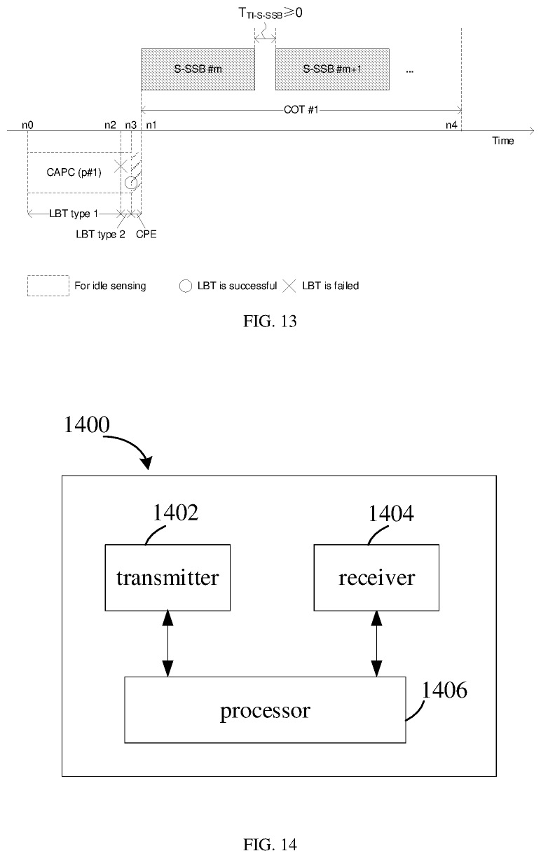

FIG. 13 illustrates an exemplary channel access procedure (e.g., alternative 6) according to some embodiments of the present application.

As shown in FIG. 13, a UE may perform a first LBT type 1 procedure (e.g., starting from a time point n0) associated with S-SSB occasion #m to initiate a first S-SSB channel occupancy starting from S-SSB occasion #m.

The first S-SSB channel occupancy may have a first COT (e.g., denoted by COT #1) from a time point n1 to a time point n4, wherein n1 is the beginning (also referred to starting boundary) of S-SSB occasion #m. The first COT may include N_{S-SSB}^{COT} (S-SSB #m) S-SSB occasions. A length of the time interval between two adjacent S-SSB occasions within the first COT may be denoted by T_{TI-S-SSB}, wherein T_{TI-S-SSB}≥0. For simplicity, FIG. 13 only illustrates two S-SSB occasions, e.g., S-SSB occasion #m and S-SSB occasion #m+1, as an example. For simplicity, S-SSB occasion #m and S-SSB occasion #m+1 are represented as S-SSB #m and S-SSB #m+1 in FIG. 13.

The first LBT type 1 procedure may be performed based on a CAPC value (e.g., denoted by p #1), wherein p #1 may be determined based on the priority for synchronization reference of the UE and the first mapping as described above or based on the first COT (e.g., N_{S-SSB}^{COT} (S-SSB #m)) of the first channel occupancy and the second mapping as described above.

In FIG. 13, the UE may determine, before the beginning of S-SSB occasion #m (e.g., at a time point n2, where n2<n1), a channel access failure based on the first LBT type 1 procedure. For example, the UE may determine a channel access failure when either condition 1 or condition 2 is met.

In response to determining the channel access failure prior to S-SSB occasion #m, the UE may perform an LBT type 2 procedure prior to S-SSB occasion #m. The specific operations may include at least one of the following steps.

Step 3-3-2-1: the UE may determine a length of a sensing interval within the time interval based on an LBT type of the first LBT type 2 procedure.

Step 3-3-2-2: the UE may perform the LBT type 2 procedure within the sensing interval.

In some cases, the UE may determine a length of CPE based on a priority for synchronization reference of the UE and the third mapping as described above. The operations for determining the length of CPE as described with respect to FIG. 12 may also apply here. In such cases, the earliest starting point of the LBT type 2 procedure is T_{SI}+T_{CPE} relative to the beginning (e.g., n1) of S-SSB occasion #m, wherein T_{SI} is the length of the sensing interval and T_{CPE} is the length of CPE. In the example of FIG. 13, the starting point of the LBT type 2 procedure is n2.

Step 3-3-2-3: in the case that a channel is determined to be available for access based on the first LBT type 2 procedure at time point n3, the UE may transmit a CPE to occupy the channel until the beginning of S-SSB occasion #m.

FIG. 14 illustrates a simplified block diagram of an exemplary apparatus 1400 for S-SSB transmission in an unlicensed spectrum according to some embodiments of the present application. In some embodiments, the apparatus 1400 may be or include at least part of a UE (e.g., UE 101a or UE 101b in FIG. 1). In some other embodiments, the apparatus 1400 may be or include at least part of a BS (e.g., BS 102 in FIG. 1).

Referring to FIG. 14, the apparatus 1400 may include at least one transmitter 1402, at least one receiver 1404, and at least one processor 1406. The at least one transmitter 1402 is coupled to the at least one processor 1406, and the at least one receiver 1404 is coupled to the at least one processor 1406.

Although in this figure, elements such as the transmitter 1402, the receiver 1404, and the processor 1406 are illustrated in the singular, the plural is contemplated unless a limitation to the singular is explicitly stated. In some embodiments of the present application, the transmitter 1402 and the receiver 1404 may be combined to one device, such as a transceiver. In some embodiments of the present application, the apparatus 1400 may further include an input device, a memory, and/or other components. The transmitter 1402, the receiver 1404, and the processor 1406 may be configured to perform any of the methods described herein (e.g., the method described with respect to any of FIGS. 5-13).

According to some embodiments of the present application, the apparatus 1400 may be a UE, and the transmitter 1402, the receiver 1404, and the processor 1406 may be configured to perform operations of the method performed by a UE as described with respect to any of FIGS. 5-13. For example, the processor 1406 may be configured to: obtain configuration information for S-SSB in an unlicensed spectrum based on configuration or pre-configuration, wherein the configuration information includes condition(s) for determining a channel access failure prior to a target S-SSB occasion based on an LBT type 1 procedure; perform a first LBT type 1 procedure associated with a first S-SSB occasion to initiate a first S-SSB channel occupancy starting from the first S-SSB occasion; and perform at least one of the following operations in response to determining a channel access failure prior to the first S-SSB occasion based on the first LBT type 1 procedure and the configuration information: performing a second LBT type 1 procedure associated with a second S-SSB occasion next to the first S-SSB occasion to initiate a second S-SSB channel occupancy starting from the second S-SSB occasion; continuing to perform the first LBT type 1 procedure prior to the second S-SSB occasion to initiate a second S-SSB channel occupancy starting from the second S-SSB occasion; or performing a first LBT type 2 procedure. The transmitter 1402 may be configured to transmit an S-SSB on the first S-SSB occasion in response to the channel being available for access prior to the first S-SSB occasion based on the first LBT type 1 procedure.

According to some embodiments of the present application, the apparatus 1400 may be a BS, and the transmitter 1402, the receiver 1404, and the processor 1406 may be configured to perform operations of the method performed by a BS as described with respect to any of FIGS. 5-13. For example, the transmitter 1402 may be configured to transmit configuration information for S-SSB in an unlicensed spectrum, wherein the configuration information includes at least one of the following: condition(s) for determining a channel access failure prior to a target S-SSB occasion based on an LBT type 1 procedure; a first mapping between CAPC value(s) and priority(ies) for synchronization reference; a second mapping between CAPC value(s) and COT(s); or a third mapping between length(s) of CPE and priority(ies) for synchronization reference.

In some embodiments of the present application, the apparatus 1400 may further include at least one non-transitory computer-readable medium. In some embodiments of the present disclosure, the non-transitory computer-readable medium may have stored thereon computer-executable instructions to cause the processor 1406 to implement any of the methods as described above. For example, the computer-executable instructions, when executed, may cause the processor 1406 to interact with the transmitter 1402 and/or the receiver 1404, so as to perform operations of the method, e.g., as described with respect to any of FIGS. 5-13.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for S-SSB transmission in an unlicensed spectrum, including a processor and a memory.

Computer programmable instructions for implementing a method for S-SSB transmission in an unlicensed spectrum are stored in the memory, and the processor is configured to perform the computer programmable instructions to implement the method for S-SSB transmission in an unlicensed spectrum. The method for S-SSB transmission in an unlicensed spectrum may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for S-SSB transmission in an unlicensed spectrum according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE), comprising:
at least one memory; and
at least one processor coupled with the at least one memory and configured to cause the UE to:
obtain configuration information for sidelink synchronization signal block (S-SSB) in an unlicensed spectrum based on configuration or pre-configuration, wherein the configuration information includes condition(s) for determining a channel access failure prior to a target S-SSB occasion based on a listen before talk (LBT) type 1 procedure;
perform a first LBT type 1 procedure associated with a first S-SSB occasion to initiate a first S-SSB channel occupancy starting from the first S-SSB occasion;
perform at least one of the following operations in response to determining a channel access failure prior to the first S-SSB occasion based on the first LBT type 1 procedure and the configuration information:
performing a second LBT type 1 procedure associated with a second S-SSB occasion next to the first S-SSB occasion to initiate a second S-SSB channel occupancy starting from the second S-SSB occasion;
continuing to perform the first LBT type 1 procedure prior to the second S-SSB occasion to initiate a second S-SSB channel occupancy starting from the second S-SSB occasion; or
performing a first LBT type 2 procedure; and
transmit an S-SSB on the first S-SSB occasion in response to a channel being available for access prior to the first S-SSB occasion based on the first LBT type 1 procedure.

2. The UE of claim 1, wherein the condition(s) for determining a channel access failure prior to a target S-SSB occasion based on an LBT type 1 procedure includes at least one of:
a defer duration of the LBT type 1 procedure cannot finish prior to the target S-SSB occasion associated with the LBT type 1 procedure; or
a random back-off procedure of the LBT type 1 procedure cannot finish prior to the target S-SSB occasion.

3. The UE of claim 1, wherein the configuration information further comprises at least one of:
a first mapping between channel access priority class (CAPC) value(s) and priority(ies) for synchronization reference;
a second mapping between CAPC value(s) and channel occupancy time(s) (COT(s)); or
a third mapping between length(s) of cyclic prefix extension (CPE) and priority(ies) for synchronization reference.

4. The UE of claim 3,
wherein a higher priority for synchronization reference is mapped to a smaller CAPC value;
wherein a COT with a shorter length is mapped to a smaller CAPC value; or
wherein a higher priority for synchronization reference is mapped to a longer CPE.

5. The UE of claim 3, wherein the at least one processor is configured to cause the UE to perform at least one of:
determining a CAPC value based on a priority for synchronization reference of the UE and the first mapping or based on a COT of the first S-SSB channel occupancy and the second mapping;
performing the first LBT type 1 procedure based on the CAPC value; or
transmitting a CPE to occupy a channel until a beginning of the first S-SSB occasion in response to the channel being available for access prior to the first S-SSB occasion based on the first LBT type 1 procedure.

6. The UE of claim 1, wherein the at least one processor is configured to cause the UE to perform a second LBT type 2 procedure associated with the second S-SSB occasion after the processor transmits the S-SSB on the first S-SSB occasion.

7. The UE of claim 6, wherein the at least one processor is configured to cause the UE to perform at least one of:
determining a time interval between the first S-SSB occasion and the second S-SSB occasion and a sensing interval within the time interval, wherein a length of the sensing interval is based on at least one of: an LBT type of the second LBT type 2 procedure or a length of the time interval;
performing the second LBT type 2 procedure associated with the second S-SSB occasion in the sensing interval; or
transmitting a CPE to occupy a channel until a beginning of the second S-SSB occasion in response to the second LBT type 2 procedure being successful before the beginning of the second S-SSB occasion.

8. The UE of claim 3, wherein the at least one processor is configured to cause the UE to perform at least one of:
determining a CAPC value based on a priority for synchronization reference of the UE and the first mapping;
performing the second LBT type 1 procedure based on the CAPC value; or
transmitting a CPE to occupy a channel until a beginning of the second S-SSB occasion in response to the channel being available for access prior to the second S-SSB occasion based on the second LBT type 1 procedure.

9. The UE of claim 3, wherein the at least one processor is configured to cause the UE to perform at least one of:
determining a CAPC value based on a COT of the second channel occupancy and the second mapping;
performing the second LBT type 1 procedure based on the CAPC value; or
transmitting a CPE to occupy a channel until a beginning of the second S-SSB occasion in response to the channel being available for access prior to the second S-SSB occasion based on the second LBT type 1 procedure.

10. The UE of claim 1, wherein the at least one processor is configured to cause the UE to transmit dummy data to occupy a channel until a beginning of the second S-SSB occasion after the channel is determined to be available for access at a time instant after the beginning of the first S-SSB occasion based on the first LBT type 1 procedure.

11. The UE of claim 1, wherein the at least one processor is configured to cause the UE to: perform a third LBT type 1 procedure associated with the second S-SSB occasion based on a smallest CAPC value after the channel is determined to be available for access at a time instant after a beginning of the first S-SSB occasion based on the first LBT type 1 procedure.

12. The UE of claim 1, wherein the first LBT type 2 procedure is performed within a time interval between the first S-SSB occasion and the second S-SSB occasion, and the at least one processor is configured to cause the UE to perform at least one of:
determining a length of a sensing interval within the time interval based on an LBT type of the first LBT type 2 procedure;
performing the first LBT type 2 procedure within the sensing interval; or
transmitting a CPE to occupy a channel until a beginning of the second S-SSB occasion in response to the channel being available for access based on the first LBT type 2 procedure.

13. The UE of claim 1, wherein the first LBT type 2 procedure is performed prior to the first S-SSB occasion in response to determining a channel access failure prior to the first S-SSB occasion based on the first LBT type 1 procedure, and the at least one processor is configured to cause the UE to perform at least one of:
determining a length of a sensing interval within a time interval based on an LBT type of the first LBT type 2 procedure;
performing the first LBT type 2 procedure within the sensing interval; or
transmitting a CPE to occupy a channel until a beginning of the first S-SSB occasion in response to the channel being available for access based on the first LBT type 2 procedure.

14. A base station (BS), comprising:
at least one memory; and
at least one processor coupled with the at least one memory and configured to cause the base station to:
transmit configuration information for sidelink synchronization signal block (S-SSB) in an unlicensed spectrum, wherein the configuration information includes at least one of the following:
condition(s) for determining a channel access failure prior to a target S-SSB occasion based on a listen before talk (LBT) type 1 procedure;
a first mapping between channel access priority class (CAPC) value(s) and priority(ies) for synchronization reference;
a second mapping between CAPC value(s) and channel occupancy time(s) (COT(s)); or
a third mapping between length(s) of cyclic prefix extension (CPE) and priority(ies) for synchronization reference.

15. A method performed by a user equipment (UE), the method comprising:
obtaining configuration information for sidelink synchronization signal block (S-SSB) in an unlicensed spectrum based on configuration or pre-configuration, wherein the configuration information includes condition(s) for determining a channel access failure prior to a target S-SSB occasion based on a listen before talk (LBT) type 1 procedure;
performing a first LBT type 1 procedure associated with a first S-SSB occasion to initiate a first S-SSB channel occupancy starting from the first S-SSB occasion;
performing at least one of the following operations in response to determining a channel access failure prior to the first S-SSB occasion based on the first LBT type 1 procedure and the configuration information:
performing a second LBT type 1 procedure associated with a second S-SSB occasion next to the first S-SSB occasion to initiate a second S-SSB channel occupancy starting from the second S-SSB occasion;
continuing to perform the first LBT type 1 procedure prior to the second S-SSB occasion to initiate a second S-SSB channel occupancy starting from the second S-SSB occasion; or
performing a first LBT type 2 procedure; and
transmitting an S-SSB on the first S-SSB occasion in response to a channel being available for access prior to the first S-SSB occasion based on the first LBT type 1 procedure.

16. A processor for wireless communication, comprising:
at least one controller coupled with at least one memory and configured to cause the processor to:
obtain configuration information for sidelink synchronization signal block (S-SSB) in an unlicensed spectrum based on configuration or pre-configuration, wherein the configuration information includes condition(s) for determining a channel access failure prior to a target S-SSB occasion based on a listen before talk (LBT) type 1 procedure;
perform a first LBT type 1 procedure associated with a first S-SSB occasion to initiate a first S-SSB channel occupancy starting from the first S-SSB occasion;
perform at least one of the following operations in response to determining a channel access failure prior to the first S-SSB occasion based on the first LBT type 1 procedure and the configuration information:
performing a second LBT type 1 procedure associated with a second S-SSB occasion next to the first S-SSB occasion to initiate a second S-SSB channel occupancy starting from the second S-SSB occasion;
continuing to perform the first LBT type 1 procedure prior to the second S-SSB occasion to initiate a second S-SSB channel occupancy starting from the second S-SSB occasion; or
performing a first LBT type 2 procedure; and
transmit an S-SSB on the first S-SSB occasion in response to a channel being available for access prior to the first S-SSB occasion based on the first LBT type 1 procedure.

17. The processor of claim 16, wherein the condition(s) for determining a channel access failure prior to a target S-SSB occasion based on an LBT type 1 procedure includes at least one of:
a defer duration of the LBT type 1 procedure cannot finish prior to the target S-SSB occasion associated with the LBT type 1 procedure; or
a random back-off procedure of the LBT type 1 procedure cannot finish prior to the target S-SSB occasion.

18. The processor of claim 16, wherein the configuration information further comprises at least one of:
a first mapping between channel access priority class (CAPC) value(s) and priority(ies) for synchronization reference;
a second mapping between CAPC value(s) and channel occupancy time(s) (COT(s)); or
a third mapping between length(s) of cyclic prefix extension (CPE) and priority(ies) for synchronization reference.

19. The processor of claim 18,
wherein a higher priority for synchronization reference is mapped to a smaller CAPC value;
wherein a COT with a shorter length is mapped to a smaller CAPC value; or
wherein a higher priority for synchronization reference is mapped to a longer CPE.

20. The processor of claim 18, wherein the at least one controller is configured to cause the processor to perform at least one of:
determining a CAPC value based on a priority for synchronization reference of the processor and the first mapping or based on a COT of the first S-SSB channel occupancy and the second mapping;
performing the first LBT type 1 procedure based on the CAPC value; or
transmitting a CPE to occupy a channel until a beginning of the first S-SSB occasion in response to the channel being available for access prior to the first S-SSB occasion based on the first LBT type 1 procedure.
